(19) United States
(12) Patent Application Publication
(10) Pub. No.: US 2008/0062524 A1
(43) Pub. Date: Mar. 13, 2008

(54) Reflective micro-optic interferometric filter and its applications

(76) Inventors: Jae-Won Song, Daegu (KR); Hyun-Dcok Kim, Daegu (KR); Jong-Hoon Lee, Daegu (KR)

Correspondence Address: PATENTS+TMS, P.C., 2849 W. ARMITAGE AVE., CHICAGO, IL, 60647, US

(21) Appl. No.: 11/900,431

(22) Filed: Sep. 11, 2007

(30) Foreign Application Priority Data
Sep. 12, 2006 (KR) 10-2006-0087722
Dec. 18, 2006 (KR) 10-2006-0129584

(51) Int. Cl. G02B 27/00

(52) U.S. Cl. 359/577

(57) ABSTRACT

The invention discloses a reflective micro-optic interferometric filter system, comprising a dual fiber collimator for expanding and outputting a beam, introduced from an input fiber, through a lens unit, collimating the beam through the lens unit, and outputting the collimated beam through an output fiber; an optical mirror for reflecting the expanded beam, outputted through the lens unit of the dual fiber collimator, and directing the reflected beam into the output fiber; and an optical plate positioned between the dual fiber collimator and the optical mirror, and having a refractive index modulation or a periodic pattern for inducing optical phase differences depending on the beam propagation path.

### CLAIM OF PRIORITY

This application claims the benefit of Korean Patent Application No. 2006-0087722 filed on 12 Sep. 2006 and No. 2006-0129584 filed on 18 Dec. 2006, in the Korean Intellectual Property Office, the disclosure of which is incorporated herein by reference.

### BACKGROUND OF THE INVENTION

1. Field of the Invention

The present invention relates to an optical filter and its applications, and in particular to a reflective micro-optic interferometric filter and its applications, which have periodic spectral responses.

2. Description of the Related Art

As WDM (Wavelength-Division Multiplexing) transmission technology continuously evolves, various optical filters are being used in optical transmission systems. Especially, optical filters with periodic spectral responses have been widely used in various applications including WDM channel monitoring, wavelength locking and stabilizing, suppressing of accumulated optical and so on. In addition, the optical filters with a relatively longer period also have been used as a gain-equalizing filter of an optical amplifier. The above-described filters having periodic spectral response can be implemented in various ways. The filters with periodic spectral responses are usually implemented based on a Mach-Zehnder interferometer (MZI), a Sagnac interferometer, a Fabry-Perot interferometer and so on. Among the filters, the MZI-based filter is well suited for a high-capacity WDM transmission system since it offers wide pass-bands and linear phase responses.

Here, the implementation technologies of the MZI-based filter can be divided into three categories: (1) planar lightwave circuit technology, (2) fused-fiber technology, and (3) micro-optic technology.

Though the filters implemented by using the planar lightwave circuit technology are compact and suitable for mass-production, but they may have poor optical characteristics such as high insertion loss and high polarization dependence loss.

The MZI-based filters implemented by using the fused-fiber technology utilize two optical couplers combining two fiber arms with different lengths and offer inherently low loss and high stability. However, it is not easy to control the optical phase difference corresponding to the spectral responses of the filters and it may require additional stabilization units to maintain to required spectral response regardless of the variation of the environments.

A representative example of the MZI-based filter implemented by using the micro-optic technology is disclosed in U.S. Pat. No. 5,930,441. The above filters have excellent optical characteristics with low insertion losses and low polarization dependence but it requires strict optical alignment process, which increases the manufacturing difficulty and the cost of the filter.

A reflective optical device whose input and output ports are located on the same side of the device are very attractive since it can reduce the device size and the mounting area.

Representative examples of the reflective MZI-based filters are disclosed in U.S. Pat. No. 6,317,265 and U.S. Pat. No. 6,507,438 B1. The above filters have excellent optical characteristics and they can be made in small size.

The configuration and operation of the conventional reflective MZI-based micro-optic filter will be described with reference to FIG. 1.

An optical signal from an input fiber is expanded by a lens unit 11 of a dual fiber collimator 10. The expanded beam propagates to a optical mirror 20 and is reflected at the optical mirror 20. The reflected beam is inputted into and collimated by the lens unit 11 of the dual fiber collimator 10, and then outputted through an output fiber. The beams may pass through a flat plate 30 before and after reflection by the optical mirror 20 and the spectral response of the filter strongly depends on the portion of the beam passing through the flat plate 30. Since the thickness of the plate is d as shown in FIG. 1, the corresponding optical phase difference is induced between the beams passing through the plate and passing through air region.

In the above reflective MZI-based micro-optic filter, it is required to precisely align to the flat plate 30 with the dual fiber collimator 10, since the filter characteristics strongly depends on the relative position of the flat plate 30 on the beam path. Furthermore, the position of the flat plate 30 should be fixed to obtain long term stability.

In other words, though the MZI-based micro-optic filter composed of a dual fiber collimator 10, a optical mirror 20 and a flat plate 30 has excellent optical characteristics, it can not be widely used due to its strict alignment requirements and long term stability problems.

Therefore, it is urgently needed to develop new interferometric filters which can mitigate strict optical alignment and enhance productivity and stability.

### SUMMARY OF THE INVENTION

Accordingly, it is an object of the present invention to provide a micro-optic interferometric filter and its applications which can overcome the problems encountered in the conventional art.

It is another object of the present invention to provide a reflective MZI-based micro-optic filter which provides a stable spectral response by employing an optical plate with a periodic refractive index modulation pattern.

In the present invention, applications of the reflective micro-optic interferometric filter are disclosed. The proposed exemplary apparatuses may overcome the conventional problems which cause manufacturing difficulties, so that the apparatus of the present invention is applicable to optical sensing device and measurement.

The present invention provides simple and superior characteristics and can be widely used to realize various optical functional blocks with high design flexibilities.

To achieve at least one of the aforementioned objects, the reflective micro-optic interferometric filter includes: a dual fiber collimator for expanding and collimating a beam; a optical mirror for reflecting the beam; and an optical plate positioned between the dual fiber collimator and the optical mirror, and having a periodic pattern for inducing optical phase difference depending on the beam path.

To achieve at least one of the aforementioned objects, an application apparatus of a reflective micro-optic interferometric filter system comprising a dual fiber collimator for expanding and outputting a beam, introduced from an input fiber, through a lens unit, collimating the beam through the lens unit, and outputting the collimated beam through an output fiber; an optical mirror for reflecting the expanded beam, outputted through the lens unit of the dual fiber collimator, and directing the reflected beam into the output fiber; and an optical plate positioned between the dual fiber collimator and the optical mirror, and having a refractive index modulation or a periodic pattern for inducing optical phase differences depending on the beam propagation path, wherein said optical plate comprises a host material formed of a periodic refraction index distribution having a step shaped repetition construction; and a sensing material engaged at the step shaped repetition construction at one side surface of the host material, the sensing material guiding an optic characteristic change with respect to a sensing object.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating a configuration of a conventional reflective micro-optic MZI filter;

FIG. 2 is a view illustrating a basic configuration of a reflective micro-optic interferometric filter according to an embodiment of the present invention;

FIG. 3 is a view illustrating a configuration of a reflective micro-optic interferometric filter according to another embodiment of the present invention;

FIG. 4 is a view illustrating a configuration of a reflective micro-optic interferometric filter according to another embodiment of the present invention;

FIG. 5 is a view illustrating various structures of an optical plate of FIGS. 2 through 4 according to the present invention.

FIG. 6 is a view illustrating an exemplary application apparatus of a micro Mach-Zehnder interferometric system, namely, a sensing and measuring apparatus according to the present invention.

FIG. 7 is view illustrating another exemplary apparatus of a micro Mach-Zehnder interferometric system, namely, a sensing and measuring apparatus according to the present invention.

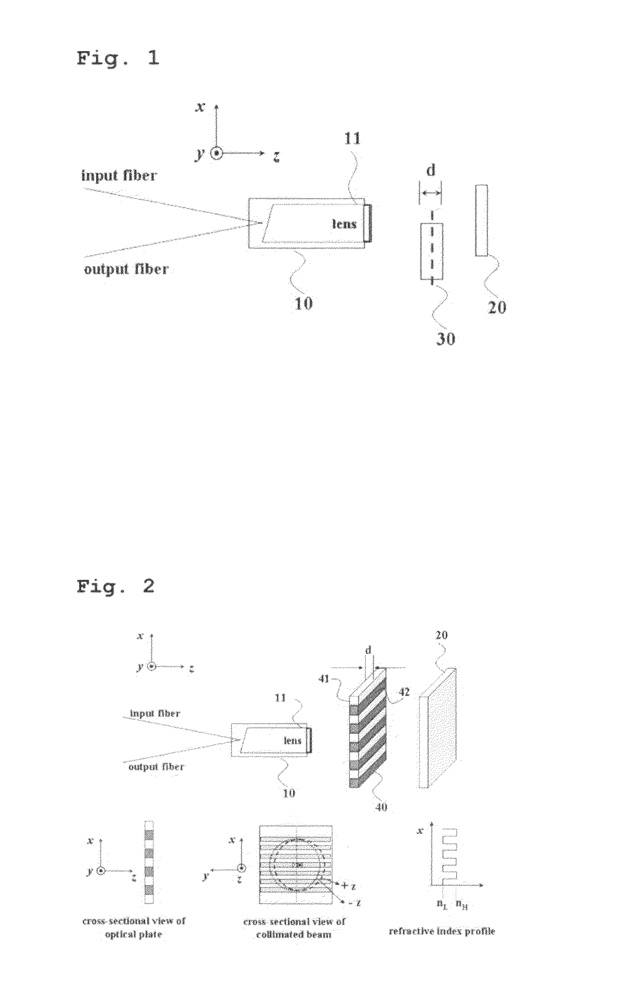

### DETAILED DESCRIPTION OF PREFERRED EMBODIMENTS OF THE INVENTION

The configuration of a reflective micro-optic interferometric filter according to a preferred embodiment of the present invention will be described with reference to FIG. 2.

A dual fiber collimator 10 has two fibers and one lens unit 11. The fibers, which can be used as an input fiber and an output fiber, and the lens unit 11 are aligned and assembled to form the dual fiber collimator 10. The dual fiber collimator acts to expand the beams from the input fiber, and combine the collimated beam into the output fiber through the lens unit 11.

An optical plate 40 according to the present invention is disposed between the dual fiber collimator 10 and an optical mirror 20.

Here, the optical mirror 20 can reflect the beams partially or totally and direct the reflected beam to the dual fiber collimator so that the beam can output through the output fiber.

The optical mirror 20 may be formed of an optical mirror with specific spectral characteristics which is capable of selectively reflecting the beams of specific wavelengths.

The operation of the filter will now be described. An optical signal from an input fiber is expanded by the dual fiber collimator 10 and propagates to the optical mirror 20 through the optical plate 40 in forward direction. The reflected beam at the optical mirror propagates to the collimator in backward direction, passes through the optical plate 40 again, and is collimated into an output fiber through the dual fiber collimator 10.

The optical plate 40 is designed to have a periodic refractive index modulation pattern. The simplest refractive 15index modulation pattern can be achieved by interleaving different materials with different refractive indexes, which forms a stripe index modulation pattern. Namely, the optical plate 40 can be formed by interleaving higher index materials 41 with a refractive index of n_{H} and lower index materials 42 with a refractive index of n_{L}. An optical phase difference occurs between the beam passing through the portions of higher index material and the beam passing through the portion of lower index material. The beam with different phases interfere each other when the beams are collimated to the output fiber through the dual fiber collimator 10. Here, the optical phase difference depends on the index difference between two kinds of materials and the thickness of the optical plate.

In more detail, the Mach-Zehnder interference occurs when some beams pass through the portions of higher index material while the other beams pass through the portions of lower index materials and combined through the collimator. If the phase difference between the beams is an integer multiple of 2π, the mode field of an output beam is unchanged, and thus the output beam is coupled to the output fiber through the dual fiber collimator 10. Then, the coupled beam is outputted though the output fiber. If the phase difference is an odd multiple of π, the mode field of an output beam is converted to a higher mode, which is not supported in the single mode fiber. Then, the converted beam is radiated and not coupled to the output fiber.

Since the reflective micro-optic filter according to the present invention is based on the MZI, the transmission characteristic of the filter can be given as the following Formula 1:

$$T = 1 - e \cdot {sin}^{2} [ \frac{π \vert {n}_{H} - {n}_{L} \vert 2 d}{λ} ] , \qquad Formula 1$$

where n_{H} is a refractive index of a higher index material, n_{L} is a refractive index of a lower index material, d is a thickness of the optical plate, λ is an optical wavelength, e is a constant determined by the ratio of beam passing through the higher index material 41 to the beam passing through the lower index material 42.

Here, the induced optical phase difference is doubled compared to that of a transmissive optical filter having the same optical plate since the optical beam passes through the optical plate twice in forward direction and backward direction.

Arbitrary interferences can be explained by the combinations of constructive interference and destructive interference. The output beam may have a complete destructive interference or a partial destructive interference, which depends on a ratio of the beam passing through the portions of a higher index to the beam passing through the portions of a lower index. The degree of interference at the final output is determined depending on the above phenomenon. Namely, some of the output beam is converted into a high order mode and the others remain in a fundamental mode of the fiber.

The extinction ratio of the reflective micro-optic interferometric filter is defined as the ratio of the maximum transmittance to the minimum transmittance of the spectral response. If the period of the refractive index modulation pattern of the optical plate 40 is much smaller as compared to the beam diameter of the expanded beam by the collimator, and the ratio of the beam passing through the portions of higher index material to the beam passing through the portions of lower index material nearly corresponds to the ratio of the plate area with higher index to the plate area with lower index. Thus the micro-optic filter will have a specific extinction ratio irrespective to the position of the optical plate 40 in the beam path. This means that the deviation of the position of the optical plate in lateral direction, x-direction as shown in FIG. 2 does not affects on the characteristics of the filter since the pattern is repeated with specific period.

Here, if the refractive index modulation pattern is a stripe the duty ration is defined as the ratio of the period of pattern to the width of the higher index material or the width of the lower index material of the optical plate. By controlling the period and the duty ratio of the refractive index modulation pattern, it is possible to achieve a desired value of the extinction ratio of the filter irrespective to the variation of the position of the optical plate.

The pattern formed on the either sides of optical plate may be constituted in various methods so as to generate optical phase differences.

FIG. 3 is a view illustrating a configuration of a reflective micro-optic interferometric filter according to another embodiment of the present invention. An optical signal from an input fiber is expanded by the dual fiber collimator 10 and propagates to the optical mirror 20 through the optical plate 50 in forward direction. The reflected beam at the optical mirror propagates to the collimator in backward direction, passes through the optical plate 50 again, and is collimated into an output fiber through the dual fiber collimator 10.

In this case, the thickness of the optical plate 50 periodically changes with position. Namely a corrugated pattern is formed on the surface of the optical plate. The refractive index of the optical plate material is usually different from the index of the air and thus the optical plate can cause optical phase difference depending on the beam path passing through the plate.

The simplest one dimensional corrugate pattern can be realized by implementing a stripe pattern through an etching process on either side of its surface.

The corrugated patterns are formed with the periodic stripe pattern, so that the optical phase difference may occur between the beams passing through the etched regions 51 (concave regions) and non-etched regions 52 (convex regions). Namely, the beams experiences optical phase difference whether they pass through the etched regions 51(concave regions) or non-etched regions 52(convex regions). The corrugated pattern formed with the stripe pattern on the substrate is positioned in the beam path, so that a phase difference may be induced.

The beams with different phases are combined through the dual fiber collimator 10 and the Mach-Zehnder interference occurs during the beam combining. The transmission characteristic of the reflective micro-optic filter as shown in FIG. 3 will be very similar with the Formula 1 since it is also based on the MZI and the structure of the optical plate is also similar.

The optical plate with a corrupted pattern can be manufactured in various ways including a semiconductor manufacturing process such as an etching method, a proton exchanging method and a molding as well as a mechanical method.

The reflective micro-optic interferometric filter according to a preferred embodiment of the present invention is implemented using a conventional fiber collimator, so that stable and easier production is possible, and the present invention may be expanded to realize various optical functional blocks or application devices.

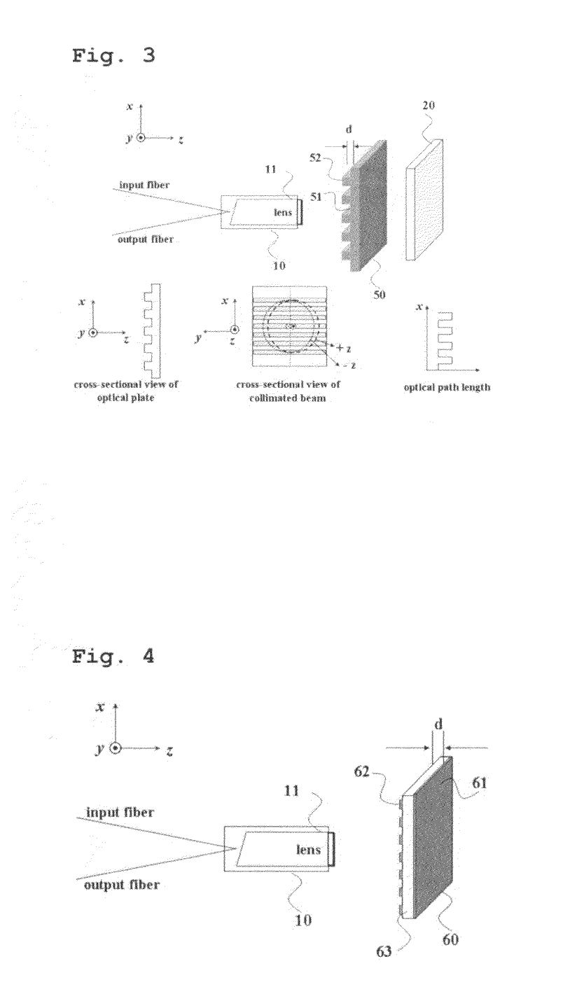

FIG. 4 is a view illustrating a structure of a reflective micro-optic interferometric filter according to another embodiment of the present invention.

As shown in FIG. 4, the optical plate 60 according to the present invention has two mirrors (61 and 62) on the both sides of a substrate 63. The front mirror 62 is disposed on one side of the substrate 63 near the dual fiber collimator 10 and the rear mirror 61 is disposed on the other side of the substrate 63.

The rear mirror 61 may be formed of a uniform optical mirror over the whole region of the rear facet of the substrate while the front mirror 62 has a periodic mirror pattern by interleaving mirror region and open region.

Here, since the mirror region and the open region are interleaved in the front facet of the substrate, some portion of the beam outputted from the dual fiber collimator 20 is reflected by the front mirror. The rear mirror 61 is a mean for reflecting the optical signal totally, thereby reflecting an optic signal from the dual fiber collimator 10 to the collimator.

The rear mirror 61 may be formed of an optical mirror with specific spectral characteristics which is capable of selectively reflecting the beams of specific wavelengths.

The rear mirror 61 performs the same functions as those of the optical mirror 20 in the aforementioned structures.

The operation of the filter will be described. An optical beam from input fiber is expanded and collimated through the lens unit 11 of the dual fiber collimator 10 and propagates to the optical plate 60. The beam is reflected by one of the mirror (61 and 62) of the optical plate 60. Since mirror region and open region are interleaved on the front facet, some portion of the beam are reflected by the front mirror 62 while the other portion of the beam are reflected by the rear mirror 61 after passing through the open region of the front facet of the optical plate. The optical collimator 10 and the optical plate 60 are placed in such a fashion that the reflected beams are coupled into the output fiber through the collimator. The beams reflected by the rear facet 61 of the optical plate propagate relatively longer optical paths before they arrive at the collimator. The Mach-Zehnder interference occurs between the beams with different phases when they are collimated into the output fiber, which leads to a wavelength-dependent spectral response of the filter.

The optical plate 60 is designed to have a periodic mirror pattern on the front facet, have a pattern in such a manner that the portions of mirror and portions of open area are interleaved on the front facet, i.e., to have an alternating strip pattern. An optical phase difference occurs between the beam reflected at the portions of the mirror 62 on the front mirror and the beam reflected at the portions of the mirror 61 at the rear mirror through the open areas of the front facet. Here, the optical phase difference depends on the refractive index and the thickness of the optical plate.

In the above embodiments, the pattern of the optical plate have a stripe pattern, but the pattern may be formed with repetitive and periodic polygon structures with a smaller size as compared to the diameter of the collimated and expanded beam of the collimator. Here, the polygon may be formed in such a manner that portions with a high index material and portions with low index material are alternately formed. In the present invention, it is obvious that the ratio between the polygons having high index material and the polygons having low index material may be adjusted to the desired extinction ratio.

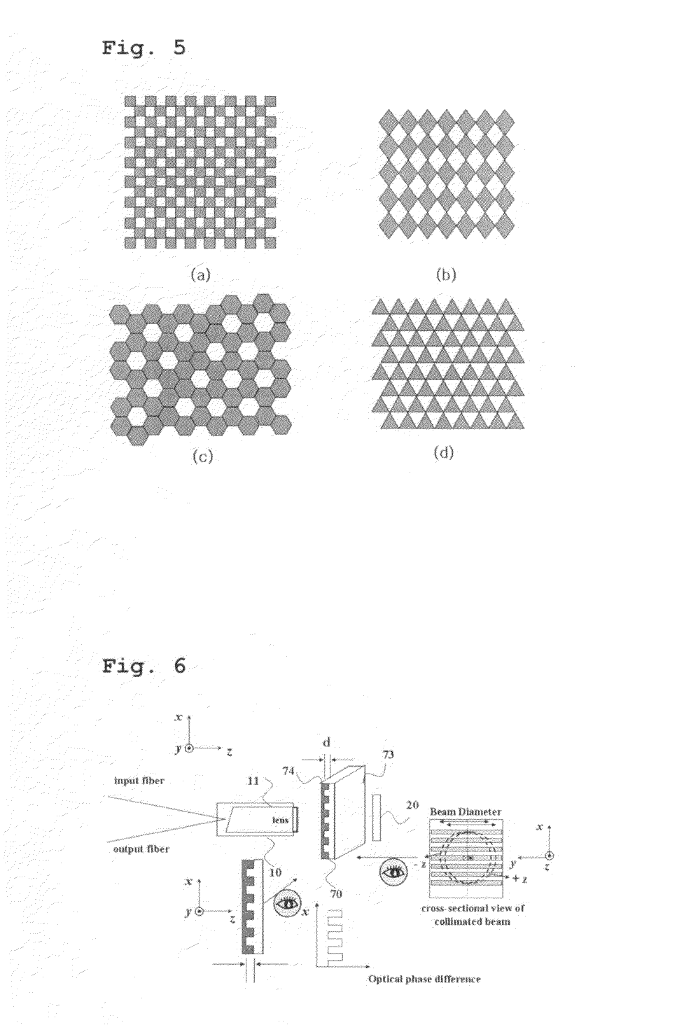

The structure of the optical plate with a periodic polygonal pattern will be described with reference to FIG. 5.

FIG. 5A is a view illustrating an example that a rectangular pattern is formed on the optical plate. In this pattern, low index material and high index material are alternately formed. Or the rectangular pattern may be formed on the optical plate, in which reflective surfaces and open areas are alternately formed. The pattern allows the beam passing through the optical plates to induce an optical phase difference in the expanded and collimated beam, and thus a specific extinction ratio can be achieved with mitigated optical alignment.

FIG. 5B is a view illustrating an example that a diamond pattern is formed on the optical plate. In this pattern, low index material and high index material are alternately formed. Or the pattern may be formed on the optical plate, in which reflective surfaces and open areas are alternately formed. The pattern allows the beam passing through the optical plates to induce an optical phase difference in the expanded and collimated beam, and thus a specific extinction ratio can be achieved with mitigated optical alignment.

FIG. 5C is a view illustrating an example that a hexagonal pattern is formed on the optical plate. In this pattern, low index material and high index material are alternately formed. Or the pattern may be formed on the optical plate, in which reflective surfaces and open areas are alternately formed. The pattern allows the beam passing through the optical plates to induce an optical phase difference in the expanded and collimated beam, and thus a specific extinction ratio can be achieved with mitigated optical alignment.

FIG. 5D is a view illustrating an example that a triangle pattern is formed on the optical plate. In this pattern, low index material and high index material are alternately formed. Or the pattern may be formed on the optical plate, in which reflective surfaces and open areas are alternately formed. The pattern allows the beam passing through the optical plates to induce an optical phase difference in the expanded and collimated beam, and thus a specific extinction ratio can be achieved with mitigated optical alignment.

In the above examples, the optical plates and the optical mirror are separate from each other, but the optical plates and the optical mirror may be formed on the same substrate.

As described above, in the present invention, it is possible to mitigate the alignment requirement of the conventional art. Namely, since the optical plate have periodic pattern, the filters can offer reliable performances irrespective to the position of the optical plate in lateral direction if the period of the pattern is chosen to proper value.

In the present invention, the optical plate can be implemented in various including semiconductor manufacturing process, which increases the design flexibility and makes it possible to produce the filter massively.

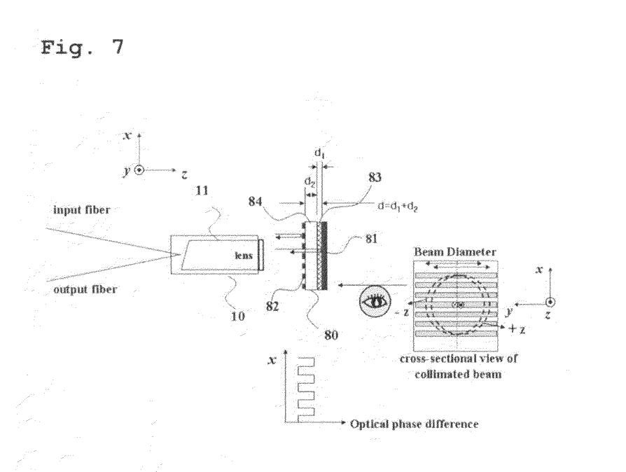

As an application of the reflective micro-optic interferometric filter according to a preferred embodiment of the present invention, the construction and operation of an exemplary apparatus of the reflective micro-optic interferometric filter according to the present invention will be described with reference to FIG. 6 and FIG. 7.

FIG. 6 is a view illustrating an exemplary application apparatus of a micro Mach-Zehnder interferometric system, namely, a sensing and measuring apparatus according to the present invention.

As shown in FIG. 6, an optical plate 70 according to a preferred embodiment of the present invention is positioned between the dual fiber collimator 10 and the optical mirror 20.

In a Mach-Zehnder interferometric system including the optical plate 70 with periodic index modulation, the optical plate 70 includes a host material 73 repeatedly formed at one side surface with a step profile, and a sensing material 74 repeatedly formed at one surface of the host material 73 with a step profile. That is, the two kinds of materials are complementary to each other and formed alternately, thereby to achieve specific transmission characteristics and/or a specific operating point and/or to measure or sense the specific kinds of variation to be targeted.

The optical plate 70 is provided for inducing a specific optical phase difference in the path of a collimated and expanded beam from the collimator, and is designed in such as fashion that some components of the beam experience a longer optical path and other components of the beam experience a shorter optical path. Here, the optical phase difference is determined by the refractive index distribution of optical plate and the junction thickness of the two materials.

The optical phase difference induced by the optical plate 70 is determined by an optical characteristic of the host material 73 and the sensing material 74. In addition, in a complementary structure which forms a relatively convex portion and concave portion, the optical phase difference is determined by a thickness d which causes a refractive index modulation by the two materials.

The optical plate 70 is formed in such a fashion that the portions having a high index material and the portions having a low index material are periodically repeated in the stripe pattern.

In an embodiment of the optical plate 70, the optical plate has a periodic index modulation pattern, and one dimensional refractive index modulation can be realized by implementing a stripe pattern through an etching on either side of its host substrate and a coating of the sensing material on the same and or vice versa. The corrugated patterns are formed with periodic stripe pattern, and thus the optical phase difference may occur between the beams passing through the etched regions (concave regions) which are filled with the sensing material and non-etched regions (convex regions) which are composed of the host material.

The optical plate 70 is provided so as to induce an optical phase difference, and the various patterns formed on the plate may be formed in various periodic repeating shapes.

The exemplary apparatus of a reflective micro-optic interferometric filter may be designed to implement desired transmission characteristics of the optical plate 70, i.e., a refractive index nₕ of the host material 73, a refractive index nₛ of the sensing material 74 and an etching depth d of the host material.

An optical signal from an input fiber is expanded and collimated through the dual fiber collimator 10, and propagates to the optical mirror 20 through the optical plate 70. The beam, reflected at the optical mirror, propagates in a reverse direction and passes through the optical plate 70 again and is condensed into an output fiber through the dual fiber collimator 10. If the relative phase difference induced by the optical plate positioned between the dual fiber collimator and the optical mirror 20 is an integer multiple of 2π, the mode field of the output beam is unchanged when it is condensed to the output fiber. If it is an odd multiple of π, the mode field of the output beam is converted to a higher mode, which can not be supported in the single mode fiber, and thus radiates out without being combined with the output fiber.

In addition, the exemplary apparatus of the reflective micro-optic interferometric filter according to the present invention defines a transmission characteristic T according to following Formula 2:

$$T = 1 - e \cdot {sin}^{2} [ \frac{π \vert {n}_{s} - {n}_{h} \vert 2 d}{λ} ] , , \qquad Formula 2$$

where nₕ is a refractive index of the host material 73, and nₛ is a refractive index of the sensing material 74, and d is a thickness of a region inducing the optical phase difference formed by the sensing material and the host material with an etching depth of the host material 73. In addition, λ is an optical wavelength.

The exemplary apparatus of the reflective micro-optic interferometric filter according to the present invention is basically designed to have a specific period and/or specific position of spectral response and/or a specific operating point by adjusting the index difference between the refractive index of the host materials 73 and the refractive index of the sensing materials 74; by adjusting a ratio between the etched portion and the non-etched portion of the host material 73; and by adjusting the etched depth d of the host material.

In addition, the exemplary apparatus of the reflective micro-optic interferometric filter according to the present invention is basically designed to constitute a sensing apparatus which can control sensitivity to as desired value by adjusting the characteristic of the sensing material 74.

The exemplary apparatus of the reflective micro-optic interferometric filter according to the present invention forms the optical plate 70 having the host material 73 and the sensing material 74 in two complementary and alternating structures.

In the above descriptions, the optical plate 70 having the host material 73 and the sensing material 74 and the optical mirror are separate from each other, but may be formed on the same substrate.

The exemplary apparatus of the reflective micro-optic interferometric filter is advantageously constituted so that a specific optical path difference may be induced and tuned by tilting the optical plate 70 to the propagation direction in the beam path between the dual fiber collimator 10 and the optical mirror 20.

FIG. 7 is view illustrating another exemplary apparatus of a micro Mach-Zehnder interferometric system, namely, a sensing and measuring apparatus according to the present invention. As shown in FIG. 7, an optical plate 80 according to a preferred embodiment of the present invention has two mirrors (82 and 81) on the both side of the optical plate. The front mirror 82 is disposed on one side of the substrate near the dual fiber collimator 10 and the rear mirror 81 is disposed on the other side of the substrate.

In a Mach-Zehnder interferometric system including an optical plate 80 with a periodic reflective mirror, the optical plate 80 comprises a host material 83 and a sensing material 84 between the front mirror 82 and the rear mirror 81, for thereby achieving specific transmission characteristics and/or a specific operating point and/or to measure or sense the specific kinds of variation to be targeted.

The optical plate 80 is provided for inducing a specific optical phase difference in the path of a collimated and expanded beam from the collimator, and is designed in such a fashion that some components of the beam experience a longer optical path and others components of the beam experience a shorter optical path. Here, the optical phase difference is determined by the refractive index and the thickness of the above two materials.

The optical plate 80 is formed so that the some components of the beams are reflected at the front mirror 82 and the others are reflected at the rear mirror 81 through the sensing material 84 and the host material 83.

An embodiment of the optical plate 80 can be realized by implementing a stripe pattern, in which the optical plate has a periodic reflective mirror pattern, and one dimensional reflective mirror pattern, mirror parts and open areas are interleaved on the front facet. Thus, the optical phase difference may occur between the beams reflecting at the front mirror and the beams reflecting at the rear mirror through the sensing material 84 and the host material 83.

The optical plate 80 is provided so as to induce an optical phase difference, and the various patterns formed on the plate may be formed in various periodic repeating shapes.

The exemplary apparatus of a reflective micro-optic interferometric filter may be designed to implement desired transmission characteristics of the optical plate 80, i.e., a refractive index nₕ of the host material, a refractive index nₛ of the sensing material, an thickness d₁ of the host material and a thickness d₂ of the sensing material.

An optical signal from an input fiber, expanded and collimated through the dual fiber collimator 10, propagate to the optical plate 80. Some components of the beam reflected at the front mirror and other components of the beam propagate through open areas of the front facet, and when reflected at the rear mirror 81, propagate to the output fiber in a reverse direction and pass through the optical plate 80 again and are condensed into an output fiber through the dual fiber collimator 10. If the relative phase difference induced by an optical plate is an integer multiple of 2π, the mode field of the output beam is unchanged when the output beam is condensed to an output fiber. If it is an odd multiple of π, the mode field of output beam is converted to a higher mode, which can not be supported in the single mode fiber, so that the output beam radiates out without being combined with an output fiber.

In addition, the exemplary apparatus of the reflective micro-optic interferometric filter according to the present invention defines a transmission characteristic T according to following Formula 3:

$$T = 1 - e \cdot {sin}^{2} [ \frac{π ( 2 {n}_{h} {d}_{1} + 2 {n}_{s} {d}_{2} )}{λ} ] , , \qquad Formula 3$$

where nₕ is a refractive index of the host material, and nₛ is a refractive index of the sensing material, d₁ is a thickness of host material, d₂ is a thickness of sensing material, and λ is an optical wavelength.

The exemplary apparatus of the reflective micro-optic interferometric filter according to the present invention is basically designed to have a specific period and/or specific position of spectral response and/or a specific operating point by adjusting the refractive index and thickness of two materials.

In addition, the exemplary apparatus of the reflective micro-optic interferometric filter according to the present invention is basically designed to constitute a sensing apparatus which can control sensitivity to a desired value by adjusting the characteristics of the sensing material.

The exemplary apparatus of the reflective micro-optic interferometric filter according to the present invention forms the optical plate 80 having two or more the host materials and the sensing material.

In the above descriptions, the optical plate 80 having the host materials and the sensing material and the front mirror 82 and the rear mirror 81 may be fabricated on the same plate, but can also be fabricated on separate substrates, respectively.

The sensing material is a material of which optical characteristics changes in accordance with an external perturbation to be measured or sensed.

The sensing material is a material of which optical phase difference changes in accordance with an external perturbation to be measured or sensed.

The sensing material is a material of which refractive index changes in accordance with an external perturbation to be measured or sensed.

The sensing material is a material of which optical thickness or width or area changes in accordance with an external perturbation to be measured or sensed.

Namely, a certain physical property is measured or sensed based upon the principle that optical characteristics of a sensing material are sensitive to a physical property to be measured or sensed. Thus, various measurement applications are possible based on optical characteristics of a sensing material as follows.

The sensing material is a material of which optical characteristic changes in accordance with temperature.

The sensing material is a material of which optical characteristic changes in accordance with a specific optical signal at specific wavelength band or a specific optical input to be measured or sensed.

The sensing material is a material of which optical characteristic changes in accordance with absorption of a certain chemical component.

The sensing material is a material of which optical characteristic changes in accordance with an external moisture change.

The sensing material is a material of which optic characteristic changes in accordance with an external pressure.

When a host material, which does not change by an external perturbation or of which characteristic is well known, is selected, it is possible to accurately measure or sense a characteristic of an unknown sensing material and vise versa.

In the above descriptions, the host material and the sensing material are described discriminatively from each other, but the interchanging between the sensing material and the host material are also possible, i.e., a cross reference between the sensing material and the host material is also possible.

The exemplary apparatus of the reflective micro-optic interferometric filter according to the present invention may use a material which has a very stable and a fixed characteristic like air, and is applicable to measure and sense a refractive index of a certain thin film using the optical plate.

The exemplary apparatus of the reflective micro-optic interferometric filter according to the present invention may be used as a sensor for measuring and sensing a certain gas or some composition of a specific gas by measuring a variation of transmission characteristic using the optical plate when a very stable material like air is used for a host material, which may be substituted by another reference medium.

The exemplary apparatus of the reflective micro-optic interferometric filter according to the present invention may be used to measure an internal concentration of specific ingredients in a specific liquid by measuring a refractive index of the specific liquid or may be used to measure the composition of specific ingredients by measuring and sensing a refractive index of liquid.

It is also possible to sense the change of a sensing material by sensing or measuring characteristic variations when a sensing material is substituted.

The sensing material is a material of which refractive index changes in accordance with the existence of a specific gas.

The exemplary apparatus of the reflective micro-optic interferometric filter according to the present invention may be used as a water sensor for sensing a variation in transmission characteristics using the optical plate when the sensing material like air is substituted with water.

Since both the sensing material and the host material are formed with stable materials, a measurement or monitoring may be implemented by referencing to fixed transmission characteristics of the host and sensing materials.

The exemplary apparatus of the reflective micro-optic interferometric filter according to the present invention may be used for monitoring a wavelength of a laser or an optical source using the optical plate.

The exemplary apparatus of the reflective micro-optic interferometric filter according to the present invention may be used for WDM channel monitoring using the optical plate.

Application ranges may be expanded by converting a first physical property into a second physical property, which can be easily measured or sensed, without directly sensing or measuring the first physical property.

The exemplary apparatus of the reflective micro-optic interferometric filter according to the present invention may be used for measuring and sensing a temporal variation of a certain vibration using the optical plate.

The exemplary apparatus of the reflective micro-optic interferometric filter according to the present invention may be used for measuring and sensing a specific acceleration or an inertial force of an object using the optical plate.

The exemplary apparatus of the reflective micro-optic interferometric filter according to the present invention may be used for converting a first physical property into a second physical property using the optical plate, if it is easy to measure or sense a change in the relative position value of the second physical property.

The present invention realizes excellent design flexibilities, which are not obtained in the conventional art. In the present invention, it is possible to widely adjust the transmission characteristic such as an operation wavelength, a bandwidth, etc., by adjusting a refractive index distribution in planar process. It is possible to freely implement a desired transmission characteristic of a desired material by selecting the sensing material and the host material, for example, by changing differences in the refractive index, thickness of junction areas or thickness of the sensing and host materials. In addition, a measuring apparatus having a desired transmission characteristic can be implemented by adjusting an optical characteristic of the sensing material like a sensitivity of the sensing material. The present invention adapts a method of adjusting a refractive index distribution in a direction that is perpendicular to the propagation direction. However, in conventional multilayer thin film filters, a refractive index distribution is adjusted in a beam propagation direction. The above-described concept of the present invention can offer one more degree of design freedom which can be realized by itself or combined with a conventional design.

As described above, in the present invention, it is possible to stably obtain a value of a specific extinction ratio or more than specific extinction ratio with a mitigated optical alignment by positioning an optical plate in a beam path, in which the optical plate has a stripe pattern of high refractive index portions and low refractive index portions formed repeatedly and alternately.

In the present invention, since an optical plate may be manufactured based on a semiconductor process technology, various manufacturing methods may be adapted using various materials. The optical plate of various structures is mass producible.

In the present invention, since design flexibilities, which were not considered in the conventional art, are increased, it is easy to implement a micro-optic interferometric system, which is capable of widely adjusting optical transmission characteristics such as a period, operation wavelength, extinction ratio, sensitivity, and etc. The present invention may allow a Mach-Zehnder interferometric system having an excellent optical characteristic to have a desired transmission characteristic. An accurate control may be implemented through an additional planar process. The design rule is simple and easy, and it is possible to effectively implement an optical system having a desired performance.

In the present invention, it is possible to implement a Mach-Zehnder interferometric system with a mitigated optical alignment.

In addition, in the present invention, a desired extinction ratio can be advantageously implemented with a mitigated optical alignment.

Furthermore, in the present invention, a Mach-Zehnder system may be implemented in a very wide operating wavelength with an achievable high extinction over the entire transmission window of an optical fiber since a converted mode by the optical plate is not supported in the optical fiber even below a single mode cutoff wavelength.

The present invention may implement an interferometric system which is capable of selecting desired operating points by an accurate optical phase control.

It is to be understood that while the present invention has been illustrated and described in relation to certain embodiments in conjunction with the accompanying drawings, such embodiments and drawings are illustrative only and that the present invention is in no event to be limited thereto. Rather, it is contemplated that modifications and equivalents embodying the principles of the present invention will no doubt occur to those of skill in the art. It is therefore contemplated and intended that the invention shall be defined by the full spirit and scope of the claims appended hereto.

1. A reflective micro-optic interferometric filter system, the system comprising:
a dual fiber collimator for expanding and outputting a beam wherein the beam is introduced from an input fiber through a lens unit wherein the lens unit collimates the beam and outputs the beam through an output fiber;
an optical mirror for reflecting the beam output from the lens unit wherein the optical mirror reflects the beam into the output fiber; and
an optical plate positioned between the dual fiber collimator and the optical mirror wherein the optical plate has a refractive index modulation or a periodic pattern for inducing optical phase differences depending on a beam propagation path.

2. The system of claim 1 wherein the optical plate with the periodic pattern is formed by interleaving a first material with a first refractive index and a second material with a second refractive index wherein the second refractive index is lower than the first refractive index.

3. The system of claim 1 wherein the optical plate with the periodic pattern has a corrupted pattern on a side of the optical plate wherein the corrupted pattern is formed by interleaving a convex region and a concave region.

4. The system of claim 1 wherein the periodic pattern is a stripe pattern.

5. The system of claim 1 wherein the periodic pattern is a polygonal pattern.

6. A reflective micro-optic interferometric filter system, the system comprising:
a dual fiber collimator for expanding and outputting a beam wherein the beam is introduced from an input fiber through a lens unit wherein the lens unit collimates the beam and outputs the beam through an output fiber;
an optical plate having a front facet and a rear facet wherein the optical plate has a periodic mirror pattern on the the front facet wherein the optical plate has a mirror on the the rear facet wherein the optical plate reflects the beam output from the lens unit of the dual fiber collimator into the output fiber wherein the optical plate induces optical phase differences depending on a beam reflection position.

7. The system of claim 6 wherein the periodic mirror pattern on the front facet is formed by interleaving mirror regions and open regions.

8. The system of claim 6 wherein the periodic mirror pattern is a stripe pattern.

9. The system of claim 6 wherein the periodic mirror pattern is a polygonal pattern.

10. An application apparatus of a reflective micro-optic interferometric filter system, the apparatus comprising:
a dual fiber collimator for expanding and outputting a beam wherein the beam is introduced from an input fiber through a lens unit wherein the lens unit collimates the beam and outputs the beam through an output fiber;
an optical mirror for reflecting the beam output from the lens unit into the output fiber; and
an optical plate positioned between the dual fiber collimator and the optical mirror wherein the optical plate has a refractive index modulation or a periodic pattern for inducing an optical phase difference depending on a beam propagation path wherein the optical plate has a host material formed of a periodic refraction index distribution having a step shaped repetition construction wherein the optical plate has a sensing material engaged at the step shaped repetition construction at one side of the host material wherein the sensing material guides an optic characteristic change with respect to a sensing object.

11. The apparatus of claim 10 wherein the periodic pattern has a periodic reflective mirror pattern to induce a specific phase difference.

12. The apparatus of claim 11 wherein the periodic reflective mirror pattern induces the optical phase difference.

13. The apparatus of claim 10 wherein the sensing material is formed of a material wherein a refractive index of the material changes in accordance with an external perturbation.

14. The apparatus of claim 10 wherein an extinction ratio is determined by adjusting a ratio of an etched portion and a non-etched portion of the host material.

15. The apparatus of claim 10 wherein the optical phase difference is capable of inducing an optical phase delay wherein the optical phase delay is caused by tilting the optical plate.

16. The apparatus of claim 10 wherein the apparatus monitors a channel signal characteristic change of a WDM.
